(19) United States
(12) Patent Application Publication
(10) Pub. No.: US 2009/0192051 A1
(43) Pub. Date: Jul. 30, 2009

(54) HIGH TEMPERATURE STABILIZER FOR WELL TREATMENT FLUIDS AND METHODS OF USING SAME

(75) Inventor: Paul S. Carman, Spring, TX (US)

Correspondence Address: HOWREY LLP, C/O IP DOCKETING DEPARTMENT, 2941 FAIRVIEW PARK DRIVE , Suite 200, FALLS CHURCH, VA, 22042, US

(73) Assignee: BJ Services Company, Houston, TX (US)

(21) Appl. No.: 12/020,755

(22) Filed: Jan. 28, 2008

(51) Int. Cl. C09K 8/24; C09K 8/62

(52) U.S. Cl. 507/117; 507/219

(57) ABSTRACT

A high temperature well treatment fluid comprising an electron donating compound comprising phenothiazine as thermal decomposition reduction additives for gels used in well treatment fluids is provided. The electron donating compound comprising phenothiazine performs as a stabilizer in well treatment fluids at temperatures of up to about 500° F. (260° C.). Methods of treating wells having subterranean formation temperatures of up to about 500° F. (260 ° C.) using such high temperature well treatment fluids are provided.

### BACKGROUND OF THE INVENTION

1. Field of the Invention

The present invention relates to the use of polymeric compounds as thermal decomposition prevention additives for well treatment fluids.

2. Description of the Related Art

Well treatment fluids are useful in hydrocarbon completion operations in various functions, such as being proppant carriers in fracturing processes or as being fluid loss control agents in well completion and workover operations. Well treatment fluids often contain gels that are formed from polymers mixed with water.

As operators continue to drill significantly deeper to access hydrocarbon bearing formations, the conditions in which well treatment fluids must operate often exceeds the maximum operational limits of conventional well treatment fluids. For example, as the drilling depths continue to increase, so do the formation temperatures in which well treatment fluids must operate. Polymeric gels, particularly guar-based polymeric gels, readily undergo auto-degradation by a number of methods at high temperatures, usually within periods of time that are shorter than necessary to complete many well treatment processes. The degradation generally gets worse as the temperatures continue to increase. Most degradation results in the cleavage of the polymer chains, which simultaneously reduces the fluid's viscosity. This can be due to oxidation from residual amounts of air entrained in the fluid, thermal induced cleavage of the acetal linkage along the polymer backbone, or both.

Well treatment fluids use both high pH (alkaline) and low pH (acidic) conditions to crosslink and maintain viscosity. However at elevated temperatures of greater than 300° F. (148.9° C.), acidic or basic hydrolysis can occur which can degrade the viscosity of the well treatment fluid and of the well treatment fluid itself. Others have attempted to reduce thermal degradation of polymeric gels by adding a gel stabilizer to the polymeric gel. For example, a stabilizer containing oxime has been used in systems having temperatures as high as 302° F. (150° C.). Unfortunately, many subterranean formations have temperatures well above this level. A need exists for well treatment fluids containing polymeric gels that are capable of being stabilized at temperatures as high as 500° F. (260° C.) as deeper wells are explored.

### SUMMARY OF THE INVENTION

In view of the foregoing, a high temperature well treatment fluid is provided as an embodiment of the present invention. The high temperature well treatment fluid includes a polymeric gel and an electron donating compound comprising phenothiazine that prevents thermal degradation of the polymeric gel at temperatures of up to about 500° F. (260° C.). The high temperature well treatment fluid can be used with various types of polymeric gels that can be crosslinked by ions, including crosslinked guar-based gels and crosslinked synthetic polymeric gels. The well treatment fluid can be used in both high pH and low pH systems.

A method for treating a well penetrating a subterranean formation having a temperature of up to about 500° F. (260° C.) is also provided as another embodiment of the present invention. In this embodiment, the method includes contacting at least a portion of the subterranean formation with a high temperature well treatment fluid. In embodiments of the present invention, the high temperature well treatment fluid includes a polymeric gel and an electron donating compound comprising phenothiazine that prevents thermal degradation of the polymeric gel at temperatures of up to about 500° F. (260° C.). In this embodiment, the high temperature well treatment fluid can be a hydraulic fracturing fluid, a drilling mud, a completion fluid, or a workover fluid.

As yet another embodiment of the present invention, a method of fracturing a subterranean formation having a temperature of up to about 500° F. (260° C.) is provided. In this embodiment, the method includes the steps of contacting water with a high temperature well treatment fluid and contacting the water and the high temperature well treatment fluid with at least a portion of the subterranean formation at pressures sufficient to form fractures in the formation. The high temperature well treatment fluid includes a polymeric gel and an electron donating compound comprising phenothiazine.

Additional additives can be added to the high temperature well treatment fluids of the present invention. Such additives can include additional monomers that can be copolymerized with the polymeric gels of the high temperature well treatment fluids, secondary stabilizers to help the high temperature well treatment fluids perform for extended periods of time, crosslinking agents to help increase the viscosity of the high temperature well treatment fluids, breakers to help break down the high temperature well treatment fluids, surfactants that help with hydration of the high temperature well treatment fluids, and the like. Other suitable additives that are useful in high temperature well treatment fluids, such as proppant, will be apparent to those of skill in the art and are to be considered within the scope of the present invention.

### BRIEF DESCRIPTION OF THE DRAWINGS

FIG. 1 is a graph of the apparent viscosity of two guar-based well treatment fluids made with and without an electron donating compound comprising phenothiazine versus time in accordance with embodiments of the present invention;

FIG. 2 is a graph of the apparent viscosity of a high molecular weight synthetic polymer-based well treatment fluid made with and without an electron donating compound comprising phenothiazine versus time in accordance with embodiments of the present invention; and

FIG. 3 is another graph of the apparent viscosity of a high molecular weight synthetic polymer-based well treatment fluid made with and without an electron donating compound comprising phenothiazine versus time in accordance with embodiments of the present invention.

While the invention is susceptible to various modifications and alternative forms, specific embodiments have been shown by way of example in the drawings and will be described in detail herein. However, it should be understood that the invention is not intended to be limited to the particular forms disclosed. Rather, the intention is to cover all modifications, equivalents and alternatives falling within the spirit and scope of the invention as defined by the appended claims.

### DESCRIPTION OF ILLUSTRATIVE EMBODIMENTS

Illustrative embodiments of the invention are described below as they might be employed in the hydrocarbon operation and in the treatment of well bores. In the interest of clarity, not all features of an actual implementation are described in this specification. It will of course be appreciated that in the development of any such actual embodiment, numerous implementation-specific decisions must be made to achieve the developers' specific goals, which will vary from one implementation to another. Moreover, it will be appreciated that such a development effort might be complex and time-consuming, but would nevertheless be a routine undertaking for those of ordinary skill in the art having the benefit of this disclosure. Further aspects and advantages of the various embodiments of the invention will become apparent from consideration of the following description.

As an embodiment of the present invention, a high temperature well treatment fluid is provided. In this embodiment, the high temperature well treatment fluid includes a polymeric gel and an electron donating compound comprising phenothiazine. The electron donating compound comprising phenothiazine is present in the high temperature well treatment fluid in an effective gel stabilizing amount that prevents thermal degradation of the polymeric gel at temperatures of up to about 500° F. (260° C.). Phenothiazine has a molecular structure as follows:

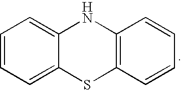

As discussed herein, hydrolysis can occur when traditional polymeric gels are exposed to elevated temperatures of greater than about 300° F. (148.9° C.). The hydrolysis process can be slowed down by protecting the site of the degradation with the electron donating compound. The electron donating compound of the present invention comprises phenothiazine, which is a very good antioxidant and free radical scavenger. Phenothiazine can donate electrons to satisfy charge of surrounding molecules. The electron donating compound functions as a high temperature stabilizer for the high temperature well treatment fluid. Phenothiazine is also an effective chain terminator because it has a sufficiently high molecular weight to terminate further reactions.

Phenothiazine is commonly used an intermediate chemical for various psychotropic drugs, as well as an insecticide. Phenothiazine, which is also called dibenzothiazine or thiodiphenylamine, can be prepared by fusing diphenylamine with sulfur. Other suitable methods of preparing phenothiazine will be apparent to those of skill in the art and are to be considered within the scope of the present invention.

In an aspect, phenothiazine can include various phenothiazine derivatives. The phenothiazine can include unsubstituted phenothiazine, unsubstituted phenothiazine 5-oxide derivative, unsubstituted phenothiazine hydrohalogenide derivative, alkyl-substituted phenothiazine, aryl-substituted phenothiazine, aroyl-substituted phenothiazine, carboxyl-substituted phenothiazine, halogen-substituted phenothiazine, N-(dialkylaminoalkyl)-substituted phenothiazine, phenothiazine-5-oxide, alkyl-substituted phenothiazine-5-oxide, aryl-substituted phenothiazine-5-oxide, aroyl-substituted phenothiazine-5-oxide, carboxyl-substituted phenothiazine-5-oxide, halogen-substituted phenothiazine-5-oxide, N-(dialkylaminoalkyl)-substituted phenothiazine-5-oxide, the hydrochlorides of these compounds, or combinations thereof. In another aspect, phenothiazine can include phenothiazine, 3-phenylphenothiazine, N-phenylphenothiazine, phenothiazine-5-oxide, 10,10′-diphenylphenothiazine, n-benzoylphenothiazine, 7-benzoylphenothiazine, 3,7-difluorophenothiazine, N-ethylphenothiazine, 2-acetylphenothiazine, 3,7-dioctylphenothiazine, N-methylphenothiazine-5-oxide, N-acetylphenothiazine, N-(2-diethylaminoethyl)-phenothiazine, N-(2-dimethylaminopropyl)-phenothiazine, N-(2-dimethylaminopropylphenothiazine)-hydrochloride, N-octadecylphenothiazine, N-propylphenothiazine, or combinations thereof. Any of the phenothiazine compounds described herein can be used as phenothiazine in embodiments of the present invention.

In an embodiment, the electron donating compound comprising phenothiazine can be present in a range of about 100 ppm to about 250 ppm of the high temperature well treatment fluid; alternatively, in a range of about 110 ppm to about 200 ppm; alternatively, in a range of about 120 ppm to about 150 ppm; or alternatively, in a range of about 120 ppm to about 140 ppm.

The electron donating compound comprising phenothiazine of the present invention can be used with various types of polymeric gels that are polymers crosslinked by ions. For example, the polymeric gel can be derived from a crosslinked polymer selected from the group consisting of galactomannan gums and their derivatives, glucomannan gums and their derivatives, guar gum, locust bean gum, cara gum, carboxymethyl guar, hydroxyethyl guar, hydroxypropyl guar carboxymethylhydroxyethyl guar, carboxymethylhydroxypropyl guar cellulose, cellulose derivatives, hydroxypropyl cellulose, hydroxymethyl cellulose, hydroxyethyl cellulose, carboxymethyl cellulose, acrylamide, polyvinyl alcohol, a copolymer of acrylamide, and combinations thereof In an aspect, the polymeric gel includes a high molecular weight copolymer derived from acrylamide. Use of a high molecular weight copolymer derived from acrylamide is described in co-pending U.S. patent application Ser. No. ______ filed on the same date as the present specification, which is incorporated herein in its entirety. The polymeric gels can also be used in the method embodiments of the present invention described herein. Other suitable polymers can be used in the present invention, as will be understood by those of skill in the art, and are to be considered within the scope of the present invention.

The phenothiazine can be supplied at a concentration of about 40 pounds per 1,000 gallons well treatment fluid to sufficiently stabilize the well treatment fluid at 400° F. (204.4° C.). Because of the shorter pumping times that are required at temperatures of less than 350° F. (176.7° C.), less phenothiazine can be used. For example, about 30 pounds per 1,000 gallons well treatment fluid is sufficient to stabilize the well treatment fluid at temperatures of less than about 350° F. (176.7° C.). In another aspect, the phenothiazine can be present in an amount effective to provide a gelled composite throughout the use of the high temperature well treatment fluid in oilfield hydraulic fracturing, drilling, completion, or workover operations.

Because phenothiazine is not soluble in water, a solution is necessary to deliver the chemical to well treatment fluids. Several solvents, including glycol ethers and esters, can be used to dissolve the phenothiazine. It was calculated that to effectively stabilize a fluid system a concentration of about 120 ppm phenothiazine in high temperature well treatment fluid was needed based upon stability data of the high temperature well treatment fluid. A suitable concentration of the electron donating compound comprising phenothiazine can be present in a range of about 100 ppm to about 250 ppm of the high temperature well treatment fluid; alternatively, in a range of about 110 ppm to about 200 ppm; alternatively, in a range of about 120 ppm to about 150 ppm; or alternatively, in a range of about 120 ppm to about 140 ppm. It is believed that solutions around 9 wt. % to 10 wt. % of phenothiazine in solution provided the best concentration for additive loadings and pour point. Toluene can also be used as a solvent to dissolve the phenothiazine. A suitable solvent is commercially available as Arcosolve® DPM, which contains dipropylene glycol methyl ether. In an aspect, the solvent is toluene, a glycol ether, a glycol ester, or combinations thereof. Other suitable solvents and effective amounts of such solvents will be apparent to those of skill in the art and are to be considered within the scope of the present invention.

The high temperature well treatment fluid can include various additives along with the polymeric gel and electron donating compound comprising phenothiazine. In an aspect, the high temperature well treatment fluid further includes a crosslinking agent in an amount sufficient to crosslink the polymeric gel. A suitable crosslinking agent can be any compound that increases the viscosity of the high temperature well treatment fluid by chemical crosslinking, physical crosslinking, or any other mechanisms. For example, the gellation of the polymer can be achieved by crosslinking the high molecular weight synthetic polymer with metal ions including boron, zirconium, and titanium containing compounds, or mixtures thereof. One class of suitable crosslinking agents is zirconium-based crosslinking agents. In another aspect, the crosslinking agent includes zirconium oxychloride, zirconium acetate, zirconium lactate, zirconium malate, zirconium glycolate, zirconium lactate triethanolamine, zirconium citrate, titanium lactate, titanium malate, titanium citrate, titanium, aluminum, iron, antimony, a zirconate-based compound, zirconium triethanolamine, an organozirconate, or combinations thereof Other suitable crosslinking agents will be apparent to those of skill in the art and are to be considered within the scope of the present invention.

The amount of the crosslinking agent needed in the high temperature well treatment fluid depends upon the well conditions and the type of treatment to be effected, but is generally in the range of from about 10 ppm to about 1000 ppm of metal ion of the crosslinking agent in the high molecular weight synthetic polymer fluid. In some applications, the aqueous polymer solution is crosslinked immediately upon addition of the crosslinking agent to form a highly viscous gel. In other applications, the reaction of the crosslinking agent can be retarded so that viscous gel formation does not occur until the desired time.

When zirconium is used as a crosslinking agent, zirconium has a built-in delay and is used from 1 gallon per 1,000 gallons to 2 gallons per 1,000 gallons depending on the temperature and high molecular weight synthetic polymer concentration in the high temperature well treatment fluid. If extra stability time is required, an additional secondary stabilizer, such as sodium thiosulfate (e.g., GS-1L from BJ Services), can be used in a range of about 1 gallon per 1,000 gallons high temperature well treatment fluid to about 3 gallons per 1,000 gallons high temperature well treatment fluid.

In an aspect of the present invention, the high temperature well treatment fluid can also include a breaker that is capable of degrading the high temperature well treatment fluid in a controlled manner to assist operators in clean up and removal of the high temperature well treatment fluid when the well treatment process is complete. For example, the breakers can assist in clean-up efforts after fracturing treatments.

Suitable breakers that can be used in the present invention will be apparent to those of skill in the art. In an aspect, the breaker comprises sodium bromate, either as is or encapsulated. In an aspect, the breaker comprises sodium bromate, ammonium persulfate, sodium persulfate, sodium perborate, sodium percarbonate, calcium peroxide, magnesium peroxide, sodium periodate, an alkaline earth metal percarbonate, an alkaline earth metal perborate, an alkaline earth metal peroxide, an alkaline earth metal perphosphate, a zinc peroxide, a zinc perphosphate, a zinc perborate, a zinc percarbonate, a boron compound, a perborate, a peroxide, a perphosphate, or combinations thereof In an embodiment, the breaker comprises sodium bromate, ammonium persulfate, sodium persulfate, sodium perborate, sodium percarbonate, calcium peroxide, magnesium peroxide, sodium periodate, or combinations thereof.

The present invention can work in both high pH and low pH systems. As can be seen in the examples, the high temperature well treatment fluid can be used in systems having high pH values that range from about 9 to about 11. As can also be seen in the examples, the low temperature well treatment fluid can be used in systems having low pH values that range from about 4.5 to about 5.25.

In an aspect, the high temperature well treatment fluid can include a pH buffer. The pH buffer of the present invention helps maintain a low pH of the high temperature well treatment fluid in a range of about 4.5 to about 5.25. In another aspect, the pH buffer comprises acetic acid and sodium acetate. In another aspect, the pH buffer comprises acetic acid, sodium acetate, formic acid, or combinations thereof. The amount of pH buffer that is needed is the amount that will effectively maintain a pH of the high temperature well treatment fluid in a range of about 4.5 to about 5.25; or alternatively, in a range of about 4.75 to about 5; or alternatively, about 5. In an aspect, the pH buffer is a true pH buffer, as opposed to a pH adjuster, as will be understood by those of skill in the art.

At temperatures above 400° F. (204.4° C.), a pH buffer comprising acetic acid and sodium acetate having a pH of 5 at 25% can be used. At temperatures below 400° F. (204.4° C.), other pH buffers can be used, such as acetic acid and formic acid buffers. Generally, any pH buffer capable of maintaining a pH of the high temperature well treatment fluid within in a range of about 4.5 to about 5.25 can be used and without interfering with the remaining components of the high temperature well treatment fluids. Other suitable pH buffers will be apparent to those of skill in the art and are to be considered within the scope of the present invention.

The pH buffer comprising acetic acid and sodium acetate having a pH of 5 can be used in a concentration ranging from about 1 gallon per 1,000 gallons high temperature well treatment fluid to about 3 gallons per 1,000 gallons high temperature well treatment fluid, depending upon the temperature of the subterranean formation.

Besides phenothiazine, the electron donating compound of the present invention can also include other compounds that are suitable for use as a secondary stabilizer. The electron donating compound functions as a stabilizer that is capable of stabilizing well treatment fluids at temperatures above what conventional stabilizers are capable of doing. Secondary stabilizers (i.e., conventional stabilizers) can be used to help the high temperature well treatment fluids perform for extended periods of time by acting as an oxygen scavenger. Secondary stabilizers can also help reduce hydrolysis, which can be a problem at temperatures greater than about 400° F. (204.4° C.).

One manner in which the electron donating compounds assist in extending run times of high temperature well treatment fluids is by maintaining the viscosity of the high temperature well treatment fluid for longer periods of time than the high temperature well treatment fluid would be capable of doing without the electron donating compound stabilizer. The secondary stabilizers can be used to help boost the stabilizing ability of the electron donating compound comprising phenothiazine, particularly at temperatures greater than about 400° F. (204.4° C.).

In an aspect, the electron donating compound can include a secondary stabilizer comprising sodium thiosulfate. A suitable secondary stabilizer that contains sodium thiosulfate is commercially available as GS-1L from BJ Services Company. Other suitable secondary stabilizers and effective amounts of such secondary stabilizers will be apparent to those of skill in the art and are to be considered within the scope of the present invention. In general, any secondary stabilizer compound capable of reducing or scavenging oxygen in the high temperature well treatment fluid long enough to perform the well treatment process (e.g., fracturing process) can be used. The amount of secondary stabilizer that can be used includes an effective amount that is capable of reducing or scavenging oxygen of the high temperature well treatment fluid long enough to perform the well treatment process (e.g., fracturing process).

Additional additives can be added to the high temperature well treatment fluid, as needed and as will be apparent to those of skill in the art. For example, proppant can be included within the high temperature well treatment fluid in embodiments of the present invention.

As another embodiment of the present invention, a method for treating a well penetrating a subterranean formation having a temperature of up to about 500° F. (260° C.) is provided. In this embodiment, a high temperature well treatment fluid is contacted with at least a portion of the subterranean formation. The high temperature well treatment fluid comprises a polymeric gel and an electron donating compound comprising phenothiazine. The electron donating compound comprising phenothiazine prevents thermal degradation of the polymeric gel at temperatures of up to about 500° F. (260° C.). In an aspect, the electron donating compound comprising phenothiazine can be present in a range of about 100 ppm to about 250 ppm of the high temperature well treatment fluid; alternatively, in a range of about 110 ppm to about 200 ppm; alternatively, in a range of about 120 ppm to about 150 ppm; or alternatively, in a range of about 120 ppm to about 140 ppm.

The method embodiments of the present invention can be used on various types of high temperature well treatment fluids. For example, in an aspect, the high temperature well treatment fluid can be a hydraulic fracturing fluid. In another aspect, the high temperature well treatment fluid can be a completion fluid. In another aspect, the high temperature well treatment fluid can be a workover fluid. It is believed that embodiments of the present invention will perform adequately in drilling, completion operations, and workover operations that typically use a comparable composition that is used in fracturing operations. For example, multi-viscous fluids are sometimes used for both completion operations and fracturing operations. It is believed that the electron donating compound comprising phenothiazine would be suitable in such applications.

As indicated previously, the polymeric gels, pH buffers, breakers, secondary stabilizers, and other additives can be used in the method embodiments described herein. Other suitable additives for high temperature well treatment fluids, such as a proppant, will be apparent to those of skill in the art and are to be considered within the scope of the present invention.

A method of fracturing a subterranean formation having a temperature of up to about 500° F. (260° C.) is provided as another embodiment of the present invention. In this embodiment, water is contacted with a high temperature well treatment fluid comprising a polymeric gel and an electron donating compound comprising phenothiazine. At least a portion of the subterranean formation is contacted with the water and the high temperature well treatment fluid at pressures sufficient to form fractures in the formation. In this embodiment, the electron donating compound is present in an effective polymeric gel stabilizing amount that prevents thermal degradation of the polymeric gel at temperatures of up to about 500° F. (260° C.). In an aspect, the electron donating compound is present in a range of about 100 ppm to about 250 ppm of the high temperature well treatment fluid; alternatively, in a range of about 110 ppm to about 200 ppm; alternatively, in a range of about 120 ppm to about 150 ppm; or alternatively, in a range of about 120 ppm to about 140 ppm.

Care should be taken in using the compositions and methods described herein to not over-stabilize the well treatment fluid because it must be broken down to remove the well treatment fluid from the wellsite at the end of the well treatment process. Typically, operators try to stabilize the well treatments for as long as possible. The high temperature electron donating compound stabilizers of the present invention perform so well at stabilizing well treatment fluids, a balance is needed to ensure that the stabilizer comprising phenothiazine adequately stabilizes the well treatment fluid, while ensuring that the operator will be able to remove the well treatment fluid easily at the end of the treatment.

### EXAMPLES

### Example 1

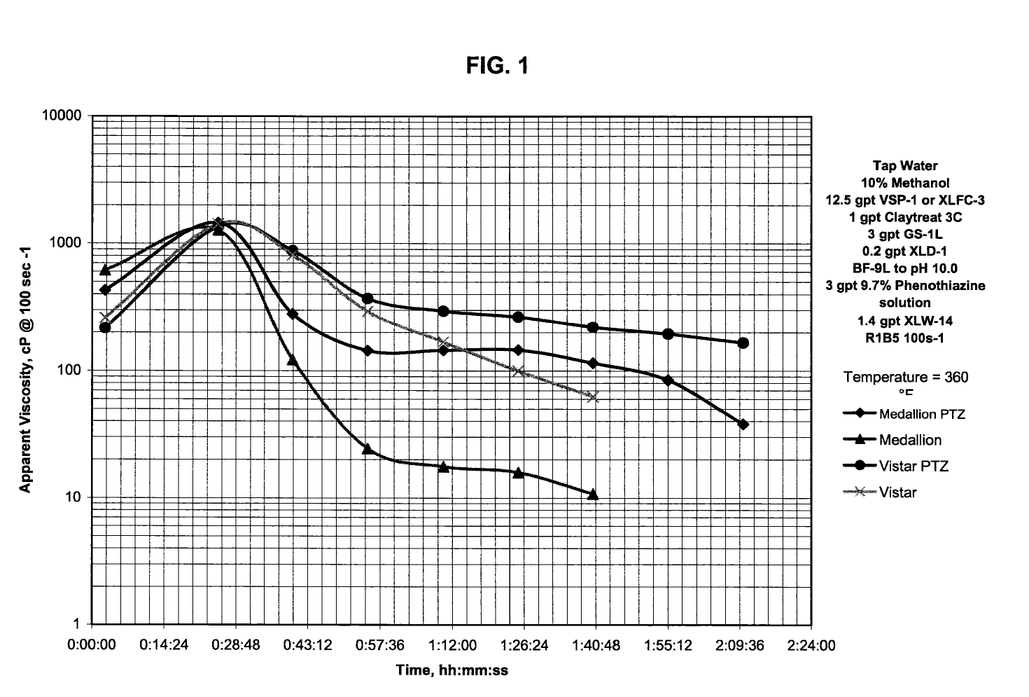

The electron donating compound comprising phenothiazine was mixed at 360° F. (182.2° C.) with two guar-based fracturing fluids that are commercially available under the commercial names Medallion Frac HT® and Vistar® from BJ Services Company. In addition order, tap water, 10 wt. % methanol, 12.5 gpt of the (slurried polymer XLFC-3 or VSP-1 by BJ Services Company respectively for Medallion Frac HT® and Vistar® 1 gpt Claytreat-3C clay stabilizer (CT-3C) by BJ Services Company, 3 gpt stabilizer (GS-1L) by BJ Services Company, 0.2 gpt crosslink delay agent (XLD-1) by BJ Services Company, and 1.4 gpt zirconate-based crosslinker (XLW-14) by BJ Services Company were mixed with 50 ppt of the fracturing fluid to produce the samples. The pH of the Medallion Frac HT® system was about 10 and the pH of the Vistar® system was about 10.25. The concentration of the electron donating compound comprising phenothiazine was 120 ppm in the fracturing fluid, i.e., 3 gpt 9.7 wt. % in dipropylene glycol methyl ether (ARCOSOLVE™ DPM) by Lyondell Chemical. As can be seen in FIG. 1, Medallion Frac HT® fluid and Vistar® fluid performed better with the stabilizing electron donating compound comprising phenothiazine added to them than without it at 360° F. (182.2° C.). The viscosity of the fracturing fluids was maintained without substantial degradation for at least 25 minutes longer than without the electron donating compound comprising phenothiazine added to it.

### Example 2

Three samples were prepared in this example. The first sample was the control sample. In the second and third samples, the electron donating compound stabilizer comprising phenothiazine was mixed at varying amounts at 400° F. (204.4° C.) with 40 ppt high molecular weight polymer-based fracturing fluid comprising a copolymer derived from acrylamide. A suitable copolymer that was used in this example is commercially available as Allessan® AG 5028P from Allessa Chemie. The pH of the samples prepared in this example was about 5. In addition order, tap water, 10 wt. % methanol, 19.1 gpt of the polymer emulsion, 1 gpt Claytreat-3C clay stabilizer (CT-3C) by BJ Services Company, 3 gpt stabilizer (GS-1L) by BJ Services Company, 2.0 gpt zirconate-based crosslinker (XLW-65) by BJ Services Company and 2 gpt low pH buffer (BF-65L) by BJ Services Company were mixed to produce the samples. The high molecular weight polymer-based fracturing fluid was made in accordance with co-pending U.S. patent application Ser. No. ______ filed on the same date as the present specification, which is incorporated herein in its entirety. Along with the polymer, a secondary stabilizer that is commercially available as GS-1L from BJ Services Company, an acetic acid sodium acetate buffer that maintains a pH of about 5, and a crosslinking agent commercially available as XLW-65 from BJ Services Company were used to create the fracturing fluid.

The first sample contained 3 gpt GS-1L stabilizer, 2 gpt acetic acid sodium acetate buffer, and 2 gpt XLW-65 from BJ Services Company crosslinking agent, with no electron donating compound stabilizer comprising phenothiazine. The electron donating compound stabilizer comprising phenothiazine was added to the second and third samples of the polymer-based fracturing fluid at a concentration of 2 gallons per 1,000 gallons fracturing fluid and 4 gallons per 1,000 gallons fracturing fluid respectively. The phenothiazine was saturated in a toluene solvent (in 3-4 wt. % solution) to aid in delivering the phenothiazine to the fracturing fluid. Besides the 2 gpt phenothiazine, the second sample contained 3 gpt GS-1L stabilizer, 2 gpt acetic acid sodium acetate-pH buffer, and 2 gpt XLW-65crosslinking agent. The third sample contained 2 gpt GS-1L stabilizer, 3 gpt acetic acid sodium acetate-pH buffer, and 2 gpt XLW-65 crosslinking agent, in addition to the 4 gpt phenothiazine.

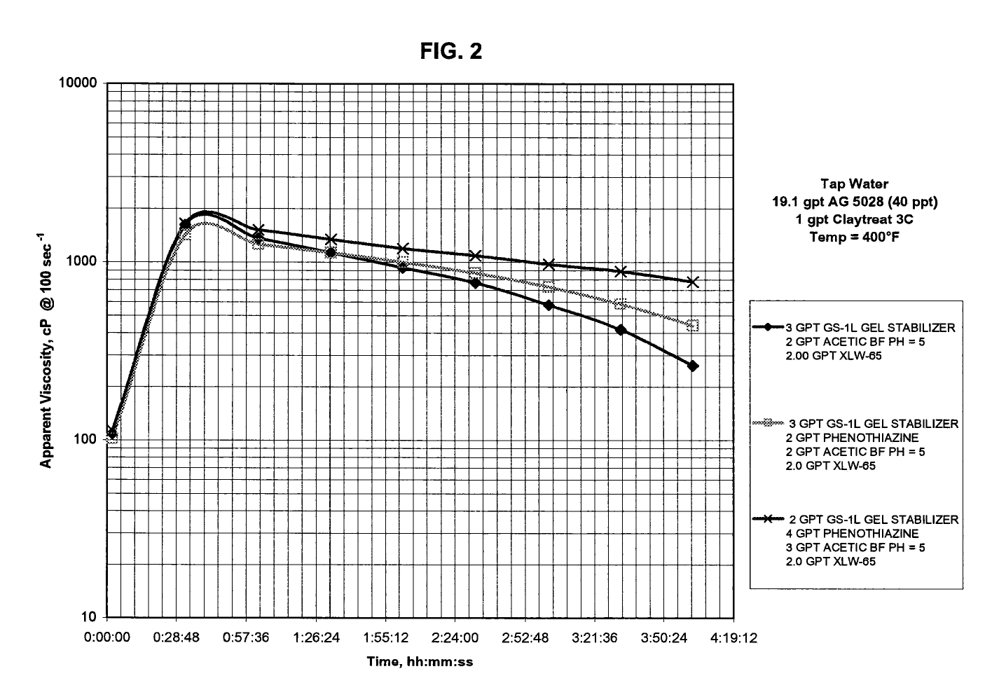

As can be seen in FIG. 2, the polymer-based fracturing fluid performed much better with the electron donating compound stabilizer comprising phenothiazine added to it than without it. The viscosity of the fracturing fluids was maintained at higher values than without the electron donating compound stabilizer comprising phenothiazine added to it. The third sample maintained its viscosity the longest out of the three samples. The more phenothiazine-containing electron donating compound stabilizer that was in the sample, the more stable the fracturing fluid in this example.

### Example 3

Five samples were prepared in this example. The first top sample was the control sample at 400° F. (204° C.). In the remaining samples, the electron donating compound stabilizer comprising phenothiazine was mixed at varying amounts at 400° F. (204.4° C.) with 40 ppt or 50 ppt high molecular weight polymer-based fracturing fluid comprising a copolymer derived from acrylamide, as indicated in Table 1. A suitable copolymer that was used in this example is commercially available as Allessan® AG 5028P from Allessa Chemie. The components, addition order, and conditions in this example are as follows:

TABLE 1

| | Sample | Sample | Sample | Sample | Sample |
|---|---|---|---|---|---|
| Component/Condition | 1 | 2 | 3 | 4 | 5 |
| Copolymer (AG 5028P), | 40 | 40 | 40 | 40 | 50 |
| ppt | | | | | |
| Gel stabilizer (GS-1L), | 3 | 3 | 2 | 2 | 1.5 |
| gpt | | | | | |
| Buffer, gpt | 2 | 2 | 3 | 3 | 2 |
| Crosslinking agent | 2 | 2 | 2 | 2 | 2 |
| (XLW-65), gpt | | | | | |
| Stabilizer, gpt | — | 2 | 4 | 4 | 4 |
| Temperature, ° F. (° C.) | 400 | 400 | 400 | 425 | 450 |

The samples were allowed to hydrate for 30 minutes. The pH of the samples prepared in this example was about 5. The high molecular weight polymer-based fracturing fluid was made in accordance with co-pending U.S. patent application Ser. No. ______ filed on the same date as the present specification, which is incorporated herein in its entirety. As shown in Table 1, along with the polymer, a secondary stabilizer that is commercially available as GS-1L from BJ Services Company, an acetic acid pH buffer that maintains a pH of 5, and a crosslinking agent commercially available as XLW-65 from BJ Services Company were used to create the fracturing fluid.

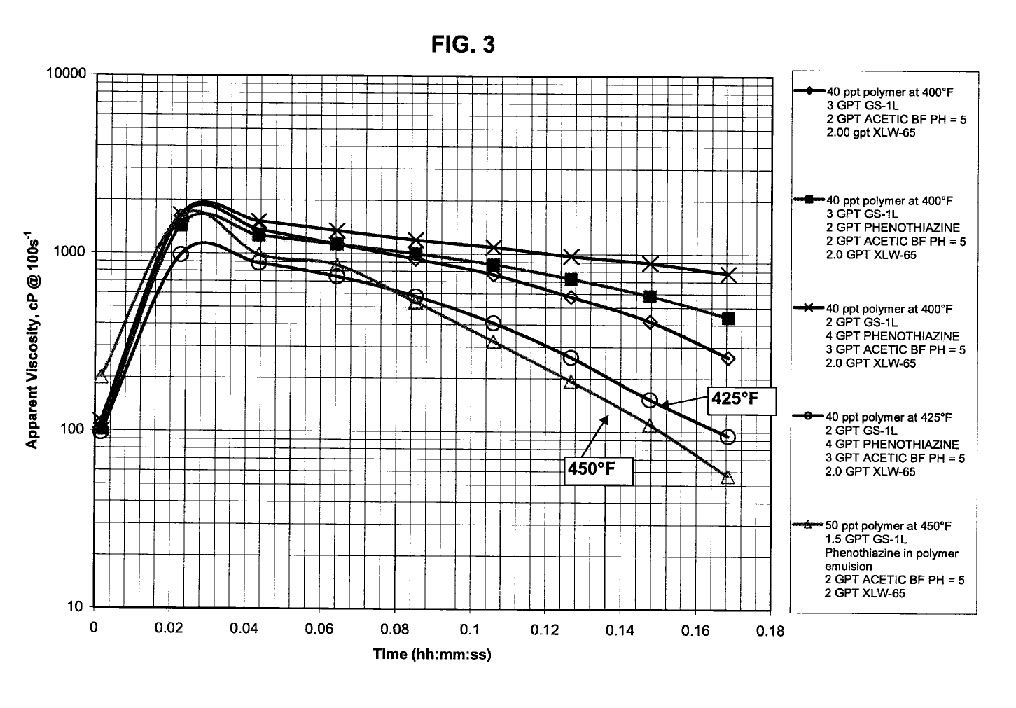

As can be seen in FIG. 3, the polymer-based fracturing fluid performed much better with the electron donating compound stabilizer comprising phenothiazine added to it than without it. The viscosity of the fracturing fluids was maintained at higher values than without the electron donating compound stabilizer comprising phenothiazine added to it. The third sample maintained its viscosity the longest out of the three samples at 400° F. (204.4° C.). The more phenothiazine-containing electron donating compound stabilizer that was in the sample, the more stable the fracturing fluid in this example.

While the invention has been shown or described in only some of its forms, it should be apparent to those skilled in the art that it is not so limited, but is susceptible to various changes without departing from the scope of the invention. For example, various types of additives can be used in the high temperature well treatment fluid of the present invention. As another example, various types of equipment can be used for the well treatment processes described herein.

What is claimed is:

1. A high temperature well treatment fluid comprising a polymeric gel and an electron donating compound comprising phenothiazine that prevents thermal degradation of the polymeric gel at temperatures of up to about 500° F. (260° C.), the phenothiazine being present in an amount effective to provide a gelled composite throughout the use of the high temperature well treatment fluid in oilfield hydraulic fracturing, drilling, completion, or workover operations.

2. The high temperature well treatment fluid of claim 1, wherein the polymeric gel comprises a crosslinked polymer derived from a polymer selected from the group consisting of galactomannan gums and their derivatives, glucomannan gums and their derivatives, guar gum, locust bean gum, cara gum, carboxymethyl guar, hydroxyethyl guar, hydroxypropyl guar carboxymethylhydroxyethyl guar, carboxymethylhydroxypropyl guar cellulose, cellulose derivatives, hydroxypropyl cellulose, hydroxymethyl cellulose, hydroxyethyl cellulose, carboxymethyl cellulose, acrylamide, polyvinyl alcohol, a copolymer of acrylamide, and combinations thereof.

3. The high temperature well treatment fluid of claim 1 further comprising a crosslinking agent in an amount sufficient to crosslink the polymeric gel.

4. The high temperature well treatment fluid of claim 3, wherein the crosslinking agent is zirconium oxychloride, zirconium acetate, zirconium lactate, zirconium malate, zirconium glycolate, zirconium lactate triethanolamine, zirconium citrate, titanium lactate, titanium malate, titanium citrate, titanium, aluminum, iron, antimony, a zirconate-based compound, zirconium triethanolamine, an organozirconate, or combinations thereof.

5. The high temperature well treatment fluid of claim 1, wherein the electron donating compound comprising phenothiazine is present in a range of about 100 ppm to about 250 ppm of the high temperature well treatment fluid.

6. The high temperature well treatment fluid of claim 1 further comprising a breaker that allows the high temperature well treatment fluid to be broken down in a controlled manner, the breaker comprising sodium bromate, ammonium persulate, sodium persulfate, sodium perborate, sodium percarbonate, calcium peroxide, magnesium peroxide, sodium periodate, or combinations thereof.

7. The high temperature well treatment fluid of claim 1 further comprising a pH buffer that maintains a pH of the high temperature well treatment fluid in a range of about 4.5 to about 5.25.

8. The high temperature well treatment fluid of claim 1 wherein the electron donating compound further comprises sodium thiosulfate.

9. A method for treating a well penetrating a subterranean formation having a temperature of up to about 500° F. (260° C.) comprising the step of contacting a high temperature well treatment fluid with at least a portion of the subterranean formation, the high temperature well treatment fluid comprising a polymeric gel and an electron donating compound comprising phenothiazine that prevents thermal degradation of the polymeric gel at temperatures of up to about 500° F. (260° C.).

10. The method of claim 9, wherein the polymeric gel comprises a crosslinked polymer derived from a polymer selected from the group consisting of galactomannan gums and their derivatives, glucomannan gums and their derivatives, guar gum, locust bean gum, cara gum, carboxymethyl guar, hydroxyethyl guar, hydroxypropyl guar carboxymethylhydroxyethyl guar, carboxymethylhydroxypropyl guar cellulose, cellulose derivatives, hydroxypropyl cellulose, hydroxymethyl cellulose, hydroxyethyl cellulose, carboxymethyl cellulose, acrylamide, polyvinyl alcohol, a copolymer of acrylamide, and combinations thereof.

11. The method of claim 9, wherein the high temperature well treatment fluid comprises a hydraulic fracturing fluid, a drilling mud, a completion fluid, or a workover fluid.

12. The method of claim 9, wherein the electron donating compound comprising phenothiazine is present in a range of about 100 ppm to about 250 ppm of the high temperature well treatment fluid.

13. The method of claim 9, wherein the high temperature well treatment fluid further comprises a pH buffer that maintains a pH of the high temperature well treatment fluid in a range of about 4.5 to about 5.25.

14. The method of claim 9, wherein the high temperature well treatment fluid further comprises a breaker that allows the high temperature well treatment fluid to be broken down in a controlled manner, the breaker comprising sodium bromate, ammonium persulate, sodium persulfate, sodium perborate, sodium percarbonate, calcium peroxide, magnesium peroxide, sodium periodate, or combinations thereof.

15. A method of fracturing a subterranean formation having a temperature of up to about 500° F. (260° C.), the method comprising the steps of:
a) contacting water with a high temperature well treatment fluid comprising a polymeric gel and an electron donating compound comprising phenothiazine; and
b) contacting at least a portion of the subterranean formation with the water and the high temperature well treatment fluid at pressures sufficient to form fractures in the formation.

16. The method of claim 15, wherein the electron donating compound comprising phenothiazine is present in a range of about 100 ppm to about 250 ppm of the high temperature well treatment fluid.

17. The method of claim 15, wherein the polymeric gel comprises a crosslinked polymer derived from a polymer selected from the group consisting of galactomannan gums and their derivatives, glucomannan gums and their derivatives, guar gum, locust bean gum, cara gum, carboxymethyl guar, hydroxyethyl guar, hydroxypropyl guar carboxymethylhydroxyethyl guar, carboxymethylhydroxypropyl guar cellulose, cellulose derivatives, hydroxypropyl cellulose, hydroxymethyl cellulose, hydroxyethyl cellulose, carboxymethyl cellulose, acrylamide, polyvinyl alcohol, a copolymer of acrylamide, and combinations thereof.

18. The method of claim 15, wherein the high temperature well treatment fluid further comprises a pH buffer that maintains a pH of the high temperature well treatment fluid in a range of about 4.5 to about 5.25.

19. The method of claim 15, wherein the high temperature well treatment fluid further comprises a breaker that allows the high temperature well treatment fluid to be broken down in a controlled manner, the breaker comprising sodium bromate, ammonium persulate, sodium persulfate, sodium perborate, sodium percarbonate, calcium peroxide, magnesium peroxide, sodium periodate, or combinations thereof.

20. The method of claim 15, wherein the electron donating compound further comprises sodium thiosulfate.
